(19) United States
(12) Patent Application Publication
(10) Pub. No.: US 2026/0288955 A1
(43) Pub. Date: Sep. 24, 2026

(54) SYSTEM AND METHOD FOR AUTOMATIC APX SIGNATURES GENERATION

(71) Applicant: Acronis International GmbH, Schaffhausen (CH)

(72) Inventors: Vladimir Strogov, Singapore (SG); Aliaksei Dodz, Singapore (SG); Serg Bell, Singapore (SG); Stanislav Protasov, Singapore (SG)

(21) Appl. No.: 19/088,214

(22) Filed: Mar. 24, 2025

(51) Int. Cl. G06F 21/56; G06F 21/12; G06F 21/64

(52) U.S. Cl. CPC G06F 21/564; G06F 21/121; G06F 21/64

(57) ABSTRACT

Systems and methods for automatically updating a code-signature library to allow for matching of malware based on generating alternative signatures based on disassembly of instructions found in compiled malware binary programs. Alternatively, systems and methods include platform-neutral, embedded, and distributed systems. Malware identified by way of the alternative signatures is then blocked or quarantined.

### TECHNICAL FIELD

The present disclosure generally relates to anti-malware solutions for computer systems. More particularly, the disclosure relates to generation of signatures for detecting malware.

### BACKGROUND

Antimalware services, including antivirus (AV) protection, are typically provided by entities that maintain extensive malware signature libraries. Most AV vendors, for example, collect and maintain signature libraries for matching scanned files and memory for possible code and data fragments, specific for certain malware. The number and accuracy of the signatures in an AV library or database determines the effectiveness of a given AV solution with respect to the efficacy of signature-based AV scans. Thus, AV vendors strive to maintain, update, and extend their signature libraries and databases so that these resources correspond as closely as possible to the current malicious threats found “in the wild” at any given time.

Malware creators and codewriters, however, know that AV vendors have such signature libraries and databases so they attempt to evade detection by AV engines. For example, a malware creator wanting to evade AV engines will generally design their malicious code to produce binaries that will not be matched with known AV signatures.

Because the effectiveness of AV engines depends on maintaining a fully updated signature collection, there is a need for improved systems and methods for updating AV signature libraries and databases.

### SUMMARY

In an embodiment, a computer-implemented technique automatically extends an antimalware signature library to address variations introduced by another CPU architecture (e.g. a second CPU architecture). Executable code patterns are identified within existing signatures in the antimalware signature library compiled for a first CPU architecture by partially disassembling the executable code patterns into opcode sequences and verifying the likelihood that the opcode sequences represent valid executable code. Alternative code signatures are generated for the second CPU architecture by disassembling the opcode sequences into corresponding assembly instructions, searching for alternative representations of the corresponding assembly instructions introduced by the second CPU architecture instruction set, and deriving alternative opcode sequences corresponding to the alternative representations of the assembly instructions. The antimalware signature library is extended by traversing the signatures in the antimalware signature library to identify sub-patterns matching the alternative opcode sequences and appending one or more alternative opcode sequences as additional sub-patterns to corresponding existing signatures in the antimalware signature library. When one or more alternative opcode sequences are detected in a computer system, execution of the corresponding binary program is blocked.

In a variation of this embodiment, the extension process is adjusted dynamically based on predefined criteria, the criteria including limiting the generation of alternative opcode sequences to a subset of patterns based on computational resource constraints and prioritizing frequently encountered alternative opcode sequence patterns. In another variation, the alternative representations include three-operand (New Data Destination, NDD) instructions, alternative enhanced vector extension (EVEX) encodings of existing instructions, instructions utilizing extended register sets with REX2 or EVEX prefixes, or simplified paired instructions, including push2 and pop2. In another embodiment, probabilistic signature matching (or scoring) assigns confidence scores to alternative signatures based on frequency and effectiveness in detecting second-CPU-architecture-based malware. Alternatively, the operation of searching for alternative representations includes analyzing combinations of instruction pairs in the original patterns for conversion into single NDD instructions and encodings for instructions supporting extended register usage with REX2 or EVEX prefixes.

Further variations include validating the extended signature library by testing the newly added alternative patterns against a database of known clean code samples to reduce false positives and scanning previously collected malicious binaries to ensure backward compatibility with existing signatures. Alternative opcode patterns for the extended signature library can be generated using predefined transformation rules specific to new CPU architecture (APX) instruction set variations. The automated process can also support additional new instruction set extensions by dynamically updating the transformation rules to incorporate new encoding formats and instruction representations.

A further embodiment comprises techniques for protecting an endpoint in a computer system. The endpoint is monitored with a security scanner and an unknown binary program associated with the endpoint is detected. A code signature of the unknown binary program is then extracted. A check is made for a match between the extracted code signature and a code signature database comprising code signatures corresponding to binary programs compiled with instructions of a first CPU architecture. The code signature database is updated if no match is found. Updating the code signature database comprises adding an alternative code signature corresponding to a binary program compiled with instructions of a second CPU architecture and checking for a match between the extracted code signature and the updated signature database. Execution of the unknown binary program is blocked at the endpoint if the extracted code signature matches the alternative code signature.

In a variation, updating the code signature database comprises requesting an update from a remote security server. In a further variation, the remote security server is coupled to a nonvolatile storage comprising a plurality of code signatures corresponding to binary programs compiled with instructions of the first CPU architecture and a plurality of alternative code signatures corresponding to binary programs compiled with the second CPU architecture. The second CPU architecture can be, for example, Intel Advanced Performance Extensions (APX) and the first CPU architecture can be Intel 64 baseline architecture. In a variation, the alternative code signature is associated with the extracted code signature as a sub-pattern.

Another embodiment comprises a system for protecting an endpoint in a computer system. The system includes a processor coupled to a memory and nonvolatile storage, along with a first code signature database in a nonvolatile storage medium comprising code signatures corresponding to binary programs compiled with instructions of a first CPU architecture. Further system components include a signature scanner for detecting unknown binary programs at the endpoint and extracting code signatures from the unknown binary programs. The first code signature database is configured to receive updates and wherein the security scanner and first code signature database are under program control of the processor. The first code signature database is further configured to receive updates comprising alternative code signatures corresponding to binary programs compiled with instructions of a second CPU architecture. The processor is configured to block execution of an unknown binary program when an extracted code signature of the unknown binary program matches an alternative code signature corresponding to binary programs compiled with instructions of a second CPU architecture.

In one implementation, the system also includes an updater module. The processor, first code signature database, signature scanner, and updater module can be installed at the endpoint or remotely. The updater module can be configured to request updates from a remote server coupled to a second code signature database. The second code signature database can include alternative code signatures corresponding to binary programs compiled with instructions of the second CPU architecture. The second CPU architecture can be, for example, APX.

### BRIEF DESCRIPTION OF THE DRAWINGS

Implementations of the invention are explained in the following detailed description of various embodiments with reference to the accompanying figures, in which:

FIG. 1 is a block diagram of a system in accordance with an embodiment.

FIG. 2 is a block diagram of an alternative system in accordance with an embodiment.

FIG. 3 is a block diagram of another alternative system in accordance with an embodiment.

FIG. 4 is a block diagram of another alternative system in accordance with an embodiment.

FIG. 5 is a flow diagram of a method in accordance with an embodiment.

FIG. 6 is a flow diagram of an alternative method in accordance with an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Systems and methods are disclosed for protecting computer systems by automatically generating new code signatures for detecting malware. When malware is detected matching the new code signature, protective action is taken to keep the binary program corresponding to the matched malware code from executing freely.

Each code signature has predetermined patterns. For example, one signature pattern comprises bytes and bits with fixed values. In some cases, the signature can also include variable values. For purposes of scanning unknown code, certain bytes or bits can be useful for identifying malware. A group of such bytes and bits comprises a signature.

A hypothetical signature can be expressed as {12, 34, ??, 56}. The four two-digit characters refer to a 4-byte sequence of bytes. For purposes of matching scanned content, a match would be found in a 4-byte sequence, where the first byte's value is “12”, the second byte's value is “34,” and the fourth byte's value is “56.” In this example, the value of the third byte (reflected by “??”) is not important and any value will be considered a match. Thus, the hypothetical signature {12, 34, ??, 56} will be matched by byte sequences {12, 34, 43, 56} and {12, 34, 56, 56}, but will not match the byte sequence {12, 34, 56, 78}.

Although this example and others described below use whole-byte signatures, the same concepts can be applied to bitwise signatures as well. Further, although signatures can comprise data and code fragments, the techniques disclosed apply specifically to signatures in the form of code fragments.

The form of code signatures found in binary programs can change depending on the processor architecture used to compile these binary programs. For example, Intel® Advanced Performance Extensions (APX) architecture, released in 2023, doubles the number of general-purpose registers (GPRs) from 16 to 32 compared to the Intel® 64 baseline architecture. These additional registers allow a compiler to store more values because of the additional available registers. For example, APX-compiled code will contain fewer loads and fewer stores than the same code compiled for an Intel® 64 baseline architecture.

To automate the generation of malware signatures adapted for new CPU architectures (such as APX), the system applies a structured workflow involving automated disassembly, opcode pattern extraction, instruction transformation detection, validation, and real-time database updates. The system dynamically extends malware signature libraries to account for instruction variations introduced by new CPU architectures, allowing continued detection of known malware even when recompiled for different instruction sets

The process begins with automated disassembly of binary executables using a specialized disassembler that extracts opcode sequences and reconstructs assembly-level instruction flow. The system then applies pattern extraction algorithms to identify signature-relevant opcode fragments, distinguishing executable code from non-code sections or compiler-generated padding. Using a predefined set of transformation rules specific to APX and other modern instruction set variations (e.g., three-operand NDD instruction transformations, alternative EVEX encodings, extended register usage via REX2 prefix, and PUSH2/POP2 optimizations), the system detects equivalent or optimized encodings, such as three-operand (New Data Destination, NDD) instruction transformations, alternative EVEX encodings, and register set expansions via REX2 prefixes. The system then generates corresponding alternative opcode sequences to extend the signature library, allowing detection of malware variants that attempt to evade conventional signature-based scanning.

The validation phase involves probabilistic signature scoring, where alternative opcode patterns are ranked based on frequency, mutation likelihood, and historical effectiveness in detecting real-world malware variants. Additionally, the system tests newly added opcode patterns against a database of known clean (safe) binaries to reduce false positives while maintaining compatibility with legacy signatures. The system also tests the ability of the updated signatures to detect known malware binary programs, which ensures that the new opcode patterns are backwards compatible. Once validated, the updated signatures are distributed across endpoint security agents, network intrusion detection systems (IDS/IPS), and cloud-based security services.

The automated process operates continuously and at scale, leveraging parallel processing for opcode comparison and database indexing to handle large signature sets with minimal performance overhead. Unlike manual rule creation by human analysts, this system enables real-time adaptation to emerging malware obfuscation techniques, allowing antivirus and endpoint protection solutions to remain effective against newly compiled APX-based threats.

In an exemplary embodiment, the focus will be automatic generation of code signatures based on the APX architecture. Generally speaking, the distinctive features of APX architecture are extended registers set with REX2 prefix, new instructions and their classes (paired push/pops, 64-bit absolute direct jump, etc.), alternative code generation approaches for existing instructions (alternative encoding of existing instruction with EVEX prefix, new three-operand (a.k.a. NDD—New Data Destination) instructions form, etc.). Chips supporting APX include the Intel® Lunar Lake processor. Compilers such as GCC 14.1+ and Clang 18.1+ support code generation for APX. For example, the GCC 14 Release indicates support for Intel APX, including EGPR, NDD, PPX and PUSH2POP2. APX support is available via the -mapxf compiler switch.

By using compilers that offer new architectural features such as APX, malware can recompile their malicious code to get new binaries that will not match existing AV's signature libraries.

For example, the function p=n*f(n-1) in the C programming language can be represented as 9 lines of assembly language (ASM) code as follows:
(1) 140001020: 8b 44 24 30 mov eax, dword ptr [rsp+0x30]
(2) 140001024: 89 44 24 2c mov dword ptr [rsp+0x2c], eax
(3) 140001028: 8b 4c 24 30 mov ecx, dword ptr [rsp+0x30]
(4) 14000102c: 83 e9 01 sub ecx, 0x1
(5) 14000102f: e8 cc ff ff ff call 0x140001000 <. text>
(6) 140001034: 89 c1 mov ecx, eax
(7) 140001036: 8b 44 24 2c mov eax, dword ptr [rsp+0x2c]
(8) 14000103a: 0f af c1 imul eax, ecx
(9) 14000103d: 89 44 24 34 mov dword ptr [rsp+0x34], eax

The same function can be represented as 8 lines using APX:
(1) 140001020: 8b 44 24 30 mov eax, dword ptr [rsp+0x30]
(2) 140001024: 89 44 24 2c mov dword ptr [rsp+0x2c], eax
(3) 140001028: 62 f4 74 18 81 6c 24 30 01 00 00 00 sub ecx, dword ptr [rsp+0x30], 0x1
(4) 140001034: e8 c7 ff ff ff call 0x140001000 <. text>
(5) 140001039: 89 c1 mov ecx, eax
(6) 14000103b: 8b 44 24 2c mov eax, dword ptr [rsp+0x2c]
(7) 14000103f: 0f af c1 imul eax, ecx
(8) 140001042: 89 44 24 34 mov dword ptr [rsp+0x34], eax

These instructions both calculate the expression “p=n*f(n-1)”. The value ‘n’ is loaded from memory into the ‘eax’ register. The expression “f(n-1)” is evaluated, and the result is stored in ‘eax’. The result of “f(n-1)” is copied from ‘eax’ into ‘ecx’. The value ‘n’ is retrieved again from memory (potentially from a different stack location). The values ‘n’ and “f(n-1)” are multiplied, and the final result (representing ‘p’) is stored in ‘eax’.

Both versions leverage memory operations (‘mov’) to load data from memory into registers and store results back. The calculation itself involves subtraction, a function call, and multiplication (‘imul’).

The non-APX version employs a standard subtraction instruction (‘sub ecx, 0x1’), while the APX version combines memory access and subtraction into a single instruction (‘sub ecx, dword ptr [rsp+0x30], 0x1’).

The function call (‘call 0x140001000’) and multiplication operations are identical in both versions.

A comparison of lines 3 and 4 in the non-APX code with line 3 of the APX code shows that the non-APX code uses two instructions to subtract 1 from the value in the ecx register. The first instruction (line 3)—‘mov ecx, dword ptr [rsp+0x30]’—moves the value from memory into ecx. The second instruction (line 4)—‘sub ecx, 0x1’—subtracts 1 from the value in ecx.

The APX version uses a single instruction (line 3) to achieve the same result. The instruction ‘sub ecx, dword ptr [rsp+0x30], 0x1’ directly subtracts 1 from the memory location and stores the result in ECX. Thus, APX instructions offer a way for malware writers to create new binaries for current malware that will produce ASM code with new signatures. In this example, the original signature (1) for the function p=n*f(n-1) differs from the APX signature (2) as shown below:
(1) Original signature: {8b, 44, 24, ??, 89, 44, 24, ??, 8b, 4c, 24, ??, 83, e9, 01, e8, ??, ??, ??, ??, 89, c1, 8b, 44, 24, ??, 0f, af, c1, c9, 44, 24, ??}; and
(2) APX signature: {8b, 44, 24, ??, 89, 44, 24, ??, 62,f4, 74, 18, 81, 6c, 24, ??, 01, 00, 00, 00, e8, ??, ??, ??, ??, 89, c1, 8b, 44, 24, ??, 0f, af, c1, c9, 44, 24, ??}.

In an exemplary embodiment, an AV signature library is automatically extended with code signatures to detect malware compiled for new architecture, for example APX. Code signatures or fragments originally compiled for x86-64 are disassembled and verified.

In an embodiment, disassembly proceeds by splitting instructions into their component parts. Continuing the example for the function p=n*f(n-1), the original signature pattern {8b, 4c, 24, ??, 83, e9, 01} can be disassembled into two instructions:
(1) mov ecx, dword ptr [rsp+??]; and
(2) sub ecx, 1.

The APX signature has at least one alternative representation using a three-operand, New Data Destination (NDD), form of “sub” instruction:
sub ecx, dword ptr [rsp+??], 1
   This subtraction instruction has following opcode-based signature:
{62, f4, 74, 18, 81, 6c, 24, ??, 01, 00, 00, 00}.
   This APX signature pattern acts as an alternative to the original signature.

This is one type of APX code variation-conversion of an instruction pair into a single NDD instruction. But the process can be applied to other instructions and opcode extensions introduced by APX. These instructions and extensions include, among others, alternative EVEX encoding of existing instructions, additional r16-r31 registers for use with existing instructions with involving REX2 or EVEX prefix, replacement of pairs of “push” and “pop” instructions with “push2” and “pop2” respectively.

Using the approach described above, the automated process traverses all signatures in a signature library/DB. For signature sub-patterns that have alternative APX representations, the signature library will be extended by adding these alternative APX representations. The alternative APX signature representations can be added, for example, to the existing entries for the signatures.

Different combinations of patterns can be appended to a signature library/DB, or only a subset of them. For example, a given signature S will have several patterns comprising {P1, P2, and P3} for which there are various alternative APX representations. For pattern P1 there exists two alternative APX representations P1.1 and P1.2. For pattern P2 there are no alternative representations. For pattern P3, there exists only one alternative APX representation, P3.1.

By replacing patterns with their alternatives one-by-one, one or more of the following new signatures can be added to the signature library:
{P1, P2, P3.1}
{P1.1, P2, P3}
{P1.1, P2, P3.1}
{P1.2, P2, P3}
{P1.2, P2, P3.1}

Embodiments can be implemented using a combination of software-based tools and specialized hardware for high-performance processing.

In an embodiment, the solution can be implemented with hardware including CPUs such as Modern x86/x64 processors (Intel, AMD) supporting APX and standard instruction sets. GPUs can also be used for accelerating disassembly and large-scale pattern matching (e.g., NVIDIA CUDA-enabled GPUs). FPGAs can be used for real-time signature matching acceleration in high-performance security appliances. In this context, a security appliance refers to a hardware device designed and programmed to perform a particular security task, such as firewalling, intrusion detection and prevention, or cryptographic acceleration. For memory, high-speed RAM (DDR4/DDR5) and NVMe SSD storage can be chosen for efficient database lookups and real-time processing.

In an embodiment, the software stack includes disassembly and analysis tools from open source or proprietary disassemblers libraries. These tools include applications comprising executable code, data, and configuration files, that interact with the operating system, processor, and other hardware resources. An exemplary application is a signature matching engine, which can be used to implement a custom pattern-matching engine optimized for opcode-level comparisons. For database management, SQL-based or NoSQL storage (e.g., PostgreSQL, MongoDB) can be used for managing signature libraries.

Network security frameworks: Suricata or Snort or other solutions allowing for integrating signature-based scanning at the network level. Operating System: Linux-based or Windows-based platforms with kernel-level security monitoring capabilities.

Embodiments of the solution can be implemented in a number of ways. For example, the solution can be implemented in a portable, platform-neutral configuration. The solution can also be implemented in specific enterprise and cloud-based security environments, where malware propagation risks are high. These different embodiments will be described in turn.

Signature processing is implemented with hardware and software that ranges from lightweight to full featured. For example, in an embodiment, a lightweight endpoint security solution is deployed on personal devices, such laptops, mobile phones, and IoT devices. A limited set of signatures are stored locally. Updates are fetched periodically from a remote database. This lightweight embodiment can be integrated into traditional antivirus programs with minimal CPU or memory overhead. In another embodiment, a full-featured enterprise security system is deployed using more powerful and resource-intensive hardware. In various embodiments, this solution runs in security operations centers (SOCs), cloud security platforms, and enterprise networks, providing endpoint security for connected devices. In some embodiments the solution uses real-time traffic monitoring, opcode transformation tracking, and signature propagation. For endpoint security, new files are scanned for matching with the updated signature collection. The solution can be integrated into Intrusion Prevention Systems (IPS), firewalls, and network security appliances. The federated signature-sharing model allows multiple enterprises to collaborate without exposing raw data.

In an embodiment, the solution is implemented in a platform-neutral version. In this embodiment, the generation of alternative code signatures takes place in isolation from any particular computing system. Alternative code signatures are generated for known malware. These alternative code signatures are added to a code-signature library. The code-signature library can be made available on-demand to authorized users. Thus, the library can be available to and used by any compatible security solution.

In an alternative embodiment, an endpoint-based lightweight implementation is employed. A low-resource version can be deployed on endpoints (workstations, mobile devices, servers). The lightweight implementation is “lightweight” because it utilizes limited database storage for local signature matching with periodic updates from a central repository. Further, embodiments are lightweight by their integration into existing antivirus engines with on-demand scanning for newly received files.

In an alternative embodiment, a centralized security gateway is implemented. A high-performance, full-featured version can be deployed at a central location, such as a corporate security operations center (SOC). In one aspect, a centralized security gateway can implement real-time analysis of all inbound/outbound traffic using a dedicated signature-matching appliance. Further, embodiments of a centralized security gateway can be used in firewalls, intrusion detection/prevention systems (IDS/IPS), and secure web gateways (SWG).

In one aspect, embodiments implement a distributed model for scalable detection. Signature database updates are handled via a federated learning model, where multiple security endpoints contribute anonymized threat intelligence. In one aspect, a distributed model can operate in hybrid cloud setups, with signature updates pushed to edge security appliances, local AV software, and cloud-based scanning tools. Decentralized malware scanning nodes perform distributed detection, reducing reliance on a single point of failure.

In an embodiment, implementations directed to corporate networks include endpoint detection and response (EDR) solutions, which benefit from real-time signature updates to block APX-evasive malware. Security information and event management (SIEM) platforms can be used to integrate the system for proactive threat intelligence. Data loss prevention (DLP) solutions monitor data movement across an organization's infrastructure. Classification of sensitive data is achieved through pattern recognition, content analysis, and metadata inspection. Policy enforcement mechanisms, triggered upon data classification, include transmission blocking, encryption, and administrative alerts in order to prevent data exfiltration.

In an embodiment directed to cloud networks, cloud-based security providers (e.g., AWS GuardDuty, Azure Security Center) are used to integrate the system for cloud-native malware scanning. Distributed databases of malware signatures are employed that can be updated across multiple data centers in real time.

In an embodiment directed to critical infrastructure and government networks, the system is used in high-security environments where signature-based malware scanning needs to be continuously updated. Firewalls and intrusion prevention systems (IPS) can integrate such solutions for deep packet inspection (DPI).

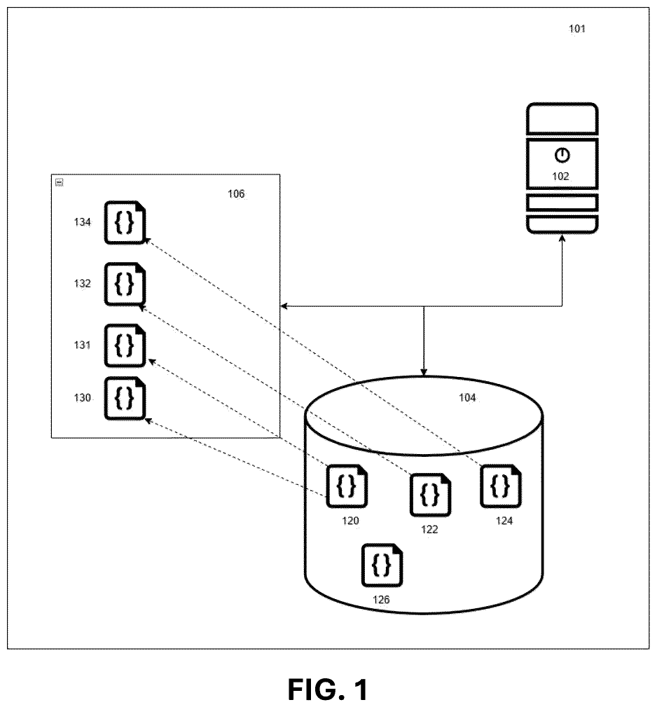

FIG. 1 shows a platform-neutral embodiment of a system 100. An AV service provider 101 processes signatures with processor 102 to update its signature libraries and databases in nonvolatile storage 104. In this example, representative signatures 120, 122, 124, and 126 are available to be used for extending. Signature 120 is used to generate alternative signatures 130 and 131. Signatures 122 and 124 are used to generate signatures 132 and 134, respectively. The alternative signatures 130-134 are added to nonvolatile storage 104. The updated collection of signatures are then available for distribution and use on any compatible security platform.

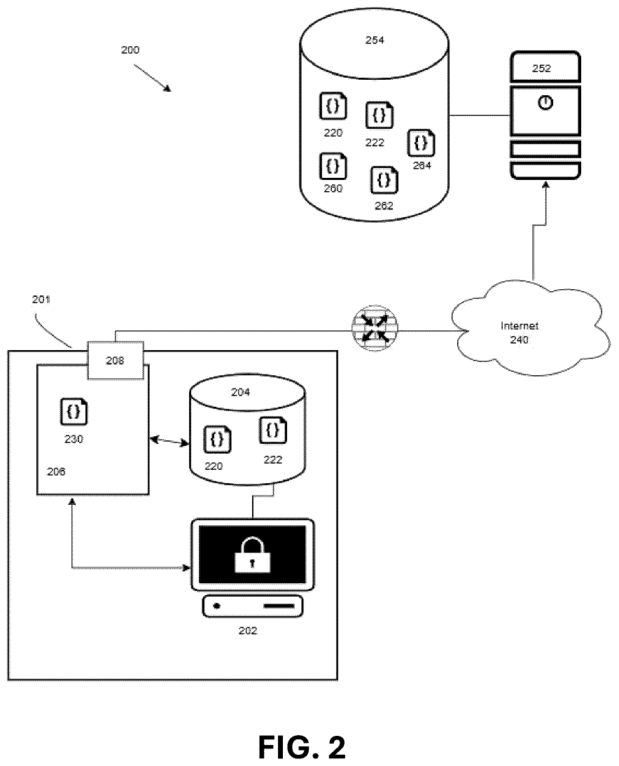

FIG. 2 shows an endpoint-based lightweight implementation of a system 200. In an embodiment, system 200 generally comprises an endpoint 201 with workstation 202 monitored by local signature scanner 206, local signature database 204, and periodic update mechanism 208. Local signature scanner 206 initializes its scanning engine and loads its configuration and signature database into RAM, then proceeds to identify scan targets based on its configuration and settings. The scanning engine traverses the file system, enumerating and filtering files. When local signature scanner 206 detects a binary program on the endpoint, signature 230 is extracted and matching is performed using the local signature database 204. If a match is found among the signatures stored in the local signature database 204, represented by signatures 220 and 222, the binary program corresponding to signature 230 is blocked or quarantined. If no match is found, the system 200 requests a signature update by way of update mechanism 208 from central server 252, for example, by way of internet connection 240. In response, central server 252 identifies any new signatures in its signature library kept in nonvolatile storage 254. The signatures in storage 254, represented in this example as signatures 260, 262, and 264, comprise new, alternative signatures generated from preexisting signatures 220 and 222. The new, alternative signatures are sent to endpoint 201 in response to the request from update mechanism 208. If local security scanner 206 determines that one of the new signatures matches the signature 230 that was detected at endpoint 201, execution of the binary program associated with signature 230 will be blocked or quarantined to protect workstation 202.

Accordingly, system 200 can include an updater module (referred to above as periodic update mechanism 208). In one aspect, the updater module can be installed at endpoint 201 or remotely. For example, endpoint 201 (or remote device) can comprise a processor as a programmable device that accepts digital and/or analog data as input, is configured to process the input according to instructions or algorithms and provides results as outputs. Endpoint 201 (or remote device) can further comprise volatile or non-volatile memory as required by the coupled processor to not only provide space to execute the instructions or algorithms, but to provide the space to store the instructions themselves. Accordingly, updater module can comprise instructions to request updates from a remote server (e.g. central server 252) coupled to a second code signature database (e.g. nonvolatile storage 254).

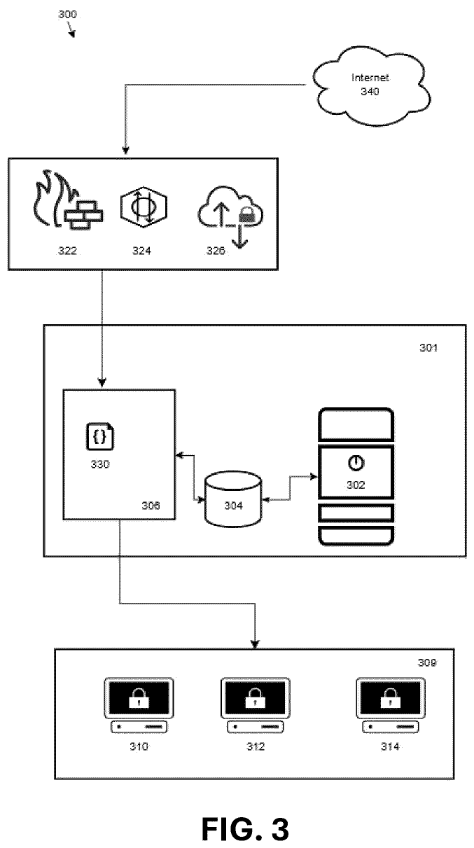

FIG. 3 shows a centralized centralized security gateway implementation of a system 300. A high-performance, full-featured version of the solution is deployed at a central location, such as corporate security operations center (SOC) 301. This operations center 301 is configured with processor 302, nonvolatile storage 304, and dedicated signature matching appliance 306. Operations center 301 is responsible for securing endpoint 309, which includes example workstations 310, 312, and 314. Real-time analysis of all inbound/outbound traffic, such as a binary program with signature 330, is performed using dedicated signature-matching appliance 306. Signature matching appliance 306 can be used in connection with firewall 322 or intrusion detection/prevention systems (IDS/IPS) 324 or secure web gateway (SWG) 326 to protect SOC 301 from unprotected access to Internet 340.

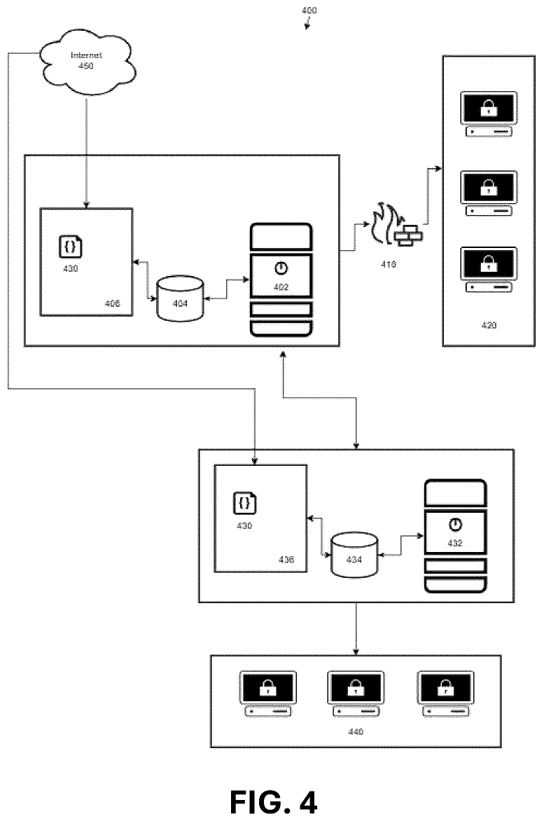

FIG. 4 shows a distributed security system 400 for large-scale malware protection. System 400 generally comprises centralized security server 402 with nonvolatile storage 404, and signature-matching appliance 406. Secondary security server 432 is configured with nonvolatile storage 434 and signature-matching appliance 436. Security server 402 is responsible for securing node 420. Security server 402 and secondary security server 436 cooperate to secure node 440. Signature matching appliances 406 and 436 monitor incoming network traffic and binary programs, whose code is represented by signature 430. A code disassembler under control of security server 402 extracts opcode-level instruction patterns from the binary program. Security server 402 identifies alternative APX-based variations and updates signatures for secondary security server 432. Signature updates are distributed across multiple endpoint devices, represented as 420 and 440. For example, signatures are distributed from security server 402 to firewall 418 for protection of endpoint 420. Security server 402 also distributes signatures to secondary security server 432. This distribution of signatures supplements the signature library in storage 434.

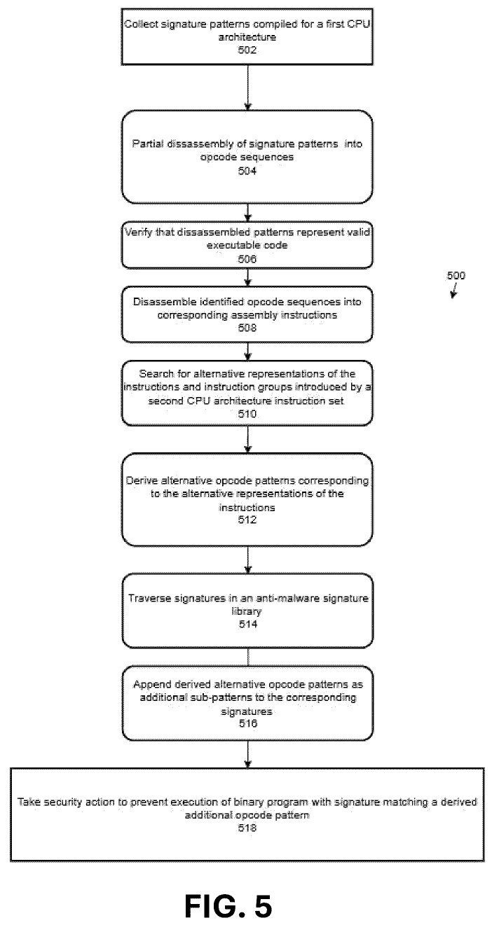

FIG. 5 shows an embodiment of a method 500 for extending a code signature library for malware detection. At 502, code signature patterns are collected. These code signatures represent binary programs compiled with a first CPU architecture, such as Intel® 64 baseline architecture. At 504, the signature patterns are partially disassembled into opcode sequences. Partial disassembly involves selectively converting code segments into assembly language for targeted examination. This technique bypasses the need for full executable disassembly. By examining the disassembled assembly code, the logic and functionality of suspect code can be understood, as well as the precise steps taken during potentially malicious actions. In various embodiments, disassemblers such as IDA Pro or Ghidra can be used to facilitate analysis. Then at 506, a verification is made that the disassembled patterns represent valid executable code. This verification can include heuristic-based filtering techniques to differentiate between executable code, embedded data, and obfuscation artifacts, thereby minimizing false positives. The filtering process may analyze instruction alignment, control flow characteristics, and frequency of opcode appearances in known benign executables. Opcode sequences are further disassembled at 508 into corresponding assembly language instructions. A search is made at 510 for alternative representation of the instructions and instruction groups introduced by a second CPU architecture instruction set, for example, Intel® Advanced Performance Extensions (APX). At 512, alternative opcode instructions are derived corresponding to alternative representations of the assembly language instructions. Derived alternative opcode sequences can be further assessed using heuristic validation to confirm their plausibility as malware-relevant execution patterns. After deriving the alternative representations, at 514 a collection of code signatures stored in a library is traversed and the derived alternative opcode patterns are appended as additional sub-patterns to their corresponding signatures at 516. To maintain detection accuracy, redundant or non-distinct alternative opcode sequences may be pruned based on statistical similarity to existing signatures. The updated signature library is used for malware detection and at 518, a security action (e.g. blocking or quarantining) is taken with respect to a binary program with a signature matching a derived additional opcode pattern.

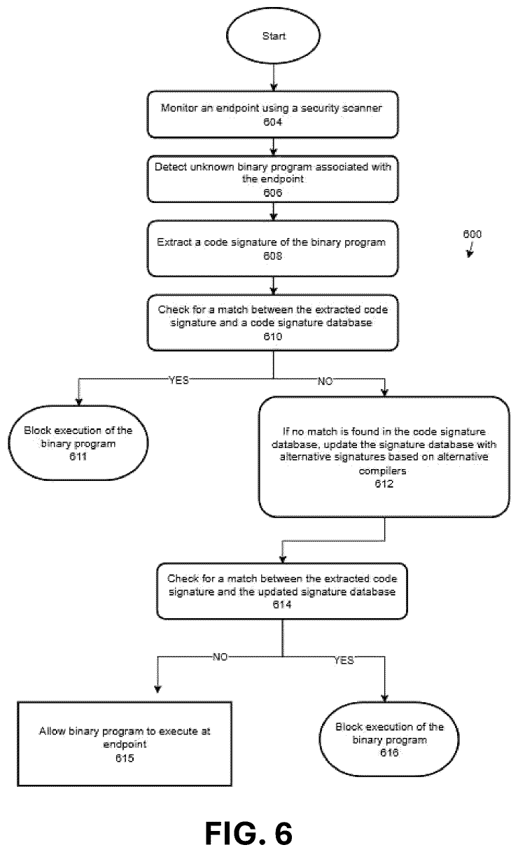

FIG. 6 shows an embodiment of a method 600 for protecting an endpoint using code signature libraries. An endpoint under protection is monitored at 604 using a security scanner. The scanner is configured to identify unknown binary programs and extract code signatures corresponding to these binary programs. At 606, a code signature is extracted from the binary program. Then a check is made between the extracted code signature and code signatures in a code-signature database at 610. If a match is detected, execution of the binary program is blocked at 611. If no match is found in the code signature database, the code signature database is updated at 612 with alternative signatures compiled with alternative instructions available for an alternative CPU architecture, such as Intel® APX. A check is made at 614 for a match between the extracted code signature and the updated signature database. If a match is found, execution of the binary program is blocked at 616. If no match is found, the binary program is allowed to execute at 615.

1. A computer-implemented method for automatically extending an antimalware signature library to address variations, the method comprising:
identifying an executable code pattern within at least one existing signature in
the antimalware signature library compiled for a first CPU architecture by:
partially disassembling the executable code patterns into opcode sequences, and
verifying the likelihood that the opcode sequences represent valid executable code;
generating alternative code signatures for a second CPU architecture by:
disassembling the opcode sequences into corresponding assembly instructions,
searching for alternative representations of the corresponding assembly instructions introduced by an instruction set of the second CPU architecture, and
deriving alternative opcode sequences corresponding to the alternative representations of the assembly instructions;
extending an antimalware signature library by:
traversing the signatures in the antimalware signature library to identify a sub-pattern matching the alternative opcode sequences,
appending one or more alternative opcode sequences as additional sub-patterns to corresponding existing signatures in the antimalware signature library; and
blocking execution of a binary program in a computer system when the one or more alternative opcode sequences is detected in the binary program.

2. The method of claim 1 further comprising: dynamically adjusting extending the antimalware signature library based on predefined criteria, the criteria including:
limiting the generation of the alternative opcode sequences to a subset of patterns based on computational resource constraints; and
prioritizing frequently encountered alternative opcode sequence patterns.

3. The method of claim 1, wherein the alternative representations include:
three-operand (New Data Destination, NDD) instructions;
alternative EVEX encodings of existing instructions;
instructions utilizing extended register sets with REX2 or EVEX prefixes; or simplified paired instructions, including push2 and pop2.

4. The method of claim 1, further comprising:
assigning confidence scores to the alternative signatures using probabilistic signature matching based on frequency and effectiveness in detecting second-CPU-architecture-based malware.

5. The method of claim 1, wherein the searching for alternative representations includes analyzing:
combinations of instruction pairs in the executable code pattern for conversion into single NDD instructions; and
encodings for instructions supporting extended register usage with REX2 or EVEX prefixes.

6. The method of claim 1, further comprising validating the antimalware signature library after extending by:
testing the alternative opcode sequences against a database of known clean code samples to reduce false positives; and
scanning previously collected malicious binaries to ensure backward compatibility with existing signatures.

7. The method of claim 1, wherein the alternative opcode sequences for the extended signature library are generated using predefined transformation rules specific to CPU architecture (APX) instruction set variations.

8. The method of claim 1, wherein new instruction set extensions are added by dynamically updating the transformation rules to incorporate new encoding formats and instruction representations.

9. A method for protecting an endpoint in a computer system, the method comprising:
monitoring the endpoint with a security scanner;
detecting an unknown binary program associated with the endpoint;
extracting a code signature of the unknown binary program;
checking for a match between the extracted code signature and a code signature database comprising code signatures corresponding to binary programs compiled with instructions of a first CPU architecture;
updating the code signature database if no match is found, wherein updating the code signature database comprising adding an alternative code signature corresponding to a binary program compiled with instructions of a second CPU architecture;
checking for a match between the extracted code signature and the updated signature database; and
blocking execution of the binary program at the endpoint if the extracted code signature matches the alternative code signature.

10. The method of claim 9, wherein the updating the code signature database comprises requesting an update from a remote security server.

11. The method of claim 10, wherein the remote security server is coupled to a remote nonvolatile storage comprising a plurality of code signatures corresponding to binary programs compiled with instructions of the first CPU architecture and a plurality of alternative code signatures corresponding to binary programs compiled with the second CPU architecture.

12. The method of claim 9, wherein the second CPU architecture is Intel Advanced Performance Extensions (APX).

13. The method of claim 12, wherein the first CPU architecture is Intel 64 baseline architecture.

14. The method of claim 9, wherein the alternative code signature is associated with the extracted code signature as a sub-pattern.

15. A system for protecting an endpoint in a computer system, the system comprising:
a processor coupled to a memory and a nonvolatile storage;
a first code signature database in the nonvolatile storage comprising code signatures corresponding to binary programs compiled with instructions of a first CPU architecture;
a signature scanner for detecting unknown binary programs at the endpoint and extracting code signatures from the unknown binary programs;
wherein the first code signature database is configured to receive updates and wherein the security scanner and first code signature database are under program control of the processor;
wherein the first code signature database is further configured to receive updates comprising alternative code signatures corresponding to binary programs compiled with instructions of a second CPU architecture; and
wherein the processor is configured to block execution of an unknown binary program when an extracted code signature of the unknown binary program matches an alternative code signature corresponding to binary programs compiled with instructions of a second CPU architecture.

16. The system of claim 15, further comprising an updater module, under processor control, configured to request updates to the first code signature database.

17. The system of claim 16, wherein the processor, first code signature database, signature scanner, and updater module are installed at the endpoint.

18. The system of claim 17, wherein the updater module is configured to request updates from a remote server coupled to a second code signature database.

19. The system of claim 18, wherein the second code signature database comprises the alternative code signature corresponding to binary programs compiled with instructions of the second CPU architecture.

20. The system of claim 19, wherein the second CPU architecture is Intel Advanced Performance Extensions (APX).
